(19) United States
(12) Patent Application Publication
(10) Pub. No.: US 2018/0014565 A1
(43) Pub. Date: Jan. 18, 2018

(54) A NATURAL SWEETENING COMPOSITION

(71) Applicant: MONTERO GIDA SANAYI VE TICARET A.S., Istanbul (TR)

(72) Inventors: Ahmet TOKSÖZ, Istanbul (TR); Zafer TOKSÖZ, Istanbul (TR); Onur MUTLU, Istanbul (TR)

(21) Appl. No.: 15/546,463

(22) PCT Filed: Jan. 26, 2016
(86) PCT No.: PCT/EP2016/051484

§ 371 Date: Jul. 26, 2017

(30) Foreign Application Priority Data
Jan. 27, 2015 (TR) 2015/00903

(51) Int. Cl. A23L 2/60

(52) U.S. Cl. CPC A23L 27/12; A23L 27/36; A23L 2/60

(57) ABSTRACT

The present invention relates to a natural sweetening composition comprising concentrates of apple and Luo Han Guo. This composition to provide the advantages of being healthy and natural, not increasing the glycemic index, production simplicity, cost-efficient and sweeter taste because of the synergy between concentrates of apple and Luo Han Guo.

### FIELD OF INVENTION

The present invention relates to a natural sweetening composition comprising concentrates of apple and Luo Han Guo. This composition to provide the advantages of being healthy and natural, not increasing the glycemic index, production simplicity, cost-efficient and sweeter taste because of the synergy between concentrates of apple and Luo Han Guo.

### BACKGROUND OF INVENTION

Luo Han Guo (luohanguo) refers to the fruit of Siraitia grosvenori, formerly called Momordica grosvenori, a member of the Curcubitaceae. The plant is cultivated for its fruit Luo Han Guo, whose extract is nearly 300 times sweeter than sugar and has been used in China as a natural low-calorie sweetener and in traditional Chinese medicine to treat diabetes and obesity. Luo Han Guo is popularly considered a longevity aid and is used to balance heat buildup caused by internal conditions, life-forces, or external heat. It is used as an expectorant and antitussive to treat lung congestion, cough, other respiratory ailments, and sore throat. It also is used for constipation and chronic enteritis. Luo Han Guo is a low-caloric, low-glycemic food used as a natural sweetener in beverages and food.

Luo Han Guo is collected as a round green fruit that turns brown upon drying. The sweet taste of Luo Han Guo comes primarily from mogrosides, a group of terpene glycosides, present at the level of about 1% of the fleshy part of the fruit. Both the fresh and dried fruits are extracted to yield a powder that is 80% or more mogrosides. The mogrosides have been numbered, 1-5, and the main component is called mogroside-5, previously known as esgoside. Other, similar compounds from Luo Han Guo have been labeled siamenoside and neomogroside. The mixed mogrosides are estimated to be about 300 times as sweet as sugar by weight, so that the 80% extracts are nearly 250 times sweeter than sugar; pure mogrosides 4 and 5 may be 400 times as sweet as sugar by weight.

A process for making a useful sweetener from Luo Han Guo was patented in 1995 by Procter and Gamble Company in U.S. Pat. No. 5,411,755. As described in the patent application, the fruit itself, though sweet, has too many additional flavors that would make it unsuitable for widespread use as a sweetener, so P&G developed a method for processing it to eliminate the undesired flavors. In the P&G process, the fresh fruit is picked before ripening and allowed to complete its ripening during storage so that processing begins with the just-ripe fruit. The peel and seeds are then removed, and the mashed fruit becomes the basis of a concentrated fruit juice or puree that can be used in food manufacturing. Further processing involves using solvents to remove volatile and off-flavor components. Numerous sugar substitutes derived from Luo Han Guo by similar processes that isolate the sweet compounds are now readily available for manufacturing and for kitchen use.

Recent work on Luo Han Guo includes investigation of the antioxidant activity of the mogrosides (Shi H, et al., Antioxidant property of fructus momordicae extract, 1996 Biochemistry and Molecular Biology International 1996; 40 (6): 1111-1121.) and their potential use as cancer prevention compounds (Konoshima T and Takasaki M, Cancer-chemopreventive effects of natural sweeteners and related compounds, Pure Applied Chemistry 2002; 74(7): 1309-1316.). This suggested effect is based on the understanding that antioxidants can produce significant reversal or suppression of the early stage of cancer development, which has been an area of particular interest for tea drinking (Katiyar S K and Mukhtar H, Tea antioxidants in cancer chemoprevention, Journal of Cellular Biochemistry, Supplement 1997; 27: 59-67.). Further, Luo Han Guo and its sweetening component are often mentioned in relation to diabetes and obesity, because it can substitute for caloric sugars normally consumed in the diet.

Apple concentrate is a flavouring, colouring and sweetening extract that contains the fruits own natural sugars. It also contains the fruit acids, minerals and secondary plant substances of apples—the polyphenolics which are nowadays regarded as positive health promoters. These polyphenolic substances are attributed with anti-oxidative and cancer-protective properties and are also regarded to have a positive effect on blood glucose and hypertension as well as lowering the cholesterol level. Further it is presumed that the positive nutritional and physiological effects of apple minerals and vitamins are associated with these secondary plant substances. Apple concentrate is a natural alternative to one of our most popular but problematic food commodities, the sucrose. For both food producers and consumers they offer various advantages to traditional sugar. Natural apple concentrate made from de-juiced and carefully dried apples that reflect the characteristic sugar spectrum, balancing the nutritional and physiological profiles with the consumers association of apple as symbol for health and vitality. The apple concentrate does not contain sucrose but a very high content of fructose.

Due to these neutral properties the potential application for natural sweetener composition is diverse, so this high quality sweetener can be used to replace sucrose in virtually every single food. Furthermore, the natural sweetener composition is process friendly with virtually the same sweetening power as traditional sugar. But to be able to claim that you are using “natural sweetener” instead of sucrose provides a consumer friendly image and a positive sales argument. The carbohydrate fructose found in the natural sweetener composition is generally recognised as diabetic sweeteners, as compared to sucrose they are sugar substitutes and metabolised independent of insulin.

In prior art, synergy is exhibited by compositions comprising sucralose and certain other high intensity sweeteners having an accompanying bitter taste, particularly saccharin, acesulfame-K and stevioside (GB 2,098,848 B), and in compositions comprising sucralose and cyclamate (GB 2,154,850 B). In GB 2 210 545A, synergistic combinations of sucralose and certain saccharides, including fructose, glucose, maltose and other gluco-oligosaccharides and sugar alcohols are disclosed. Furthermore no synergy has been disclosed between concentrates of apple and Luo Han Guo yet.

From these findings, it might be concluded that synergy between sucralose and other sweeteners is obvious. However, we have now found that apple concentrate also exhibits synergy with Luo Han Guo concentrate, in some cases to a considerable degree.

### DESCRIPTION OF THE INVENTION

Health trends have promoted an increased use of natural sweeteners in consumer diets. Amongst the many possibilities available to product developers is the option to enrich foods with “healthy ingredients” or perhaps to exchange one or more ingredients of the recipe in order to optimise the nutritional profile.

For instance foods, which do not include additives or sugar, are perceived by the consumer, as natural and healthy. Despite their immense popularity, sweeteners and particularly sucrose recently gained bad publicity because of health concerns. That's why fruit sweeteners are becoming more and more important as a natural alternative to sucrose as they contain the fruit's own sugar spectrum.

Although synthetic sweetener compositions, provide the most desirable taste to consumers, but they are caloric and unhealthy. However, numerous natural and synthetic sweeteners are non-caloric; however, they exhibit sweet tastes that have different temporal profiles, maximal responses, flavor profiles, mouthfeels, and/or adaptation behaviors than that of sugar.

For example, the sweet tastes of natural sweeteners are slower in onset and longer in duration than the sweet taste produced by synthetic sweetener and thus change the taste balance of a food composition. Because of these differences, use of synthetic sweetener to replace a bulk sweetener, in a food or beverage, causes an unbalanced temporal profile and/or flavor profile. In addition to the difference in temporal profile, synthetic sweeteners generally exhibit:
(i) lower maximal response than sugar,
(ii) tastes including bitter, metallic, cooling, astringent, licorice-like taste, etc.,
(iii) sweetness which diminishes on iterative tasting.

It is well known to those skilled in the art of food/beverage formulation that changing the sweetener in a composition requires re-balancing of the flavor and other taste components. If the taste profile of natural sweeteners could be modified to impart specific desired taste characteristics to be more sugar-like, the type and variety of compositions that may be prepared with that sweetener would be expanded significantly. Accordingly, it would be desirable to selectively modify the taste characteristics of natural sweeteners.

Of increasing nutritional and physiological importance to today's consumer is the glycemic index (GI) that is much lower for fructose compared to that of glucose. Using glucose as the standard base, with a GI of 100, fructose has a GI of around only 20. The GI measures the glycemic response (an indication of the rate at which the blood glucose level rises and how it is sustained over time) after ingestion of carbohydrate foods. The consumption of food with low GI, such as fruit and vegetables, results in a slow increase of the blood glucose level. Food with a high GI, such as sucrose and white bread, results in a quick response of blood glucose insulin levels and therefore should not only be avoided by diabetics, but also by the growing number of health conscious consumers as there is growing evidence that over long time, a diet based on high-carbohydrate low-glycemic foods is beneficial towards health by preventing chronic diseases such as diabetes, coronary heart disease and possibly cancer.

The main object of this invention is to obtain a sweetener composition that has sweeter taste because of the synergy between concentrates of apple and Luo Han Guo.

Another main object of the present invention is to obtain a sweetener composition that does not increase the glycemic index.

Another main object of the present invention is to obtain a sweetener composition that is natural and healthy.

This invention relates to a natural sweetening composition comprising concentrates of apple and Luo Han Guo, the composition is exhibiting synergy, i. e. providing greater sweetness than would be expected from simple summation of the sweetness contributed by the component sweetening agents.

It also would be desirable to improve the taste of ingestible compositions that include natural ingredients to promote their use and the resulting health benefits. In this composition, the natural sweeteners apple concentrate and Luo Han Guo concentrate do not carry any glycemic index potential. Thus, a product is obtained which can be used by those who are in diets or by the diabetics.

The embodiment described above provides a sweetener composition, which does not raise the glycemic index and provides the advantage of production simplicity.

In present invention, the phrase “concentrate” includes any apple or Luo Han Guo product that is solid or liquid comprising “extract”, “concentrated extract”, “juice”, “dried fruit”, “de-juiced fruit”, “lyophilized”, “spray dried” or mixtures thereof.

In a particular embodiment, combinations of natural sweeteners improving composition suppress, reduce, or eliminate undesirable taste and impart sugar-like characteristics to the sweetener. As used herein, the phrase “undesirable taste” includes any taste property which is not imparted by sugars. Non-limiting examples of undesirable tastes include delayed sweetness onset, lingering sweet aftertaste, metallic taste, bitter taste, cooling sensation taste or menthol-like taste, licorice-like taste, and/or the like.

As used herein, the phrases “sugar-like characteristic,” “sugar-like taste,” “sugar-like sweet,” “sugary,” and “sugar-like” are synonymous. Sugar-like characteristics include any characteristic similar to that of sucrose and include, but are not limited to, maximal response, flavor profile, temporal profile, adaptation behavior, mouthfeel, concentration/response function behavior, tastant and flavor/sweet taste interactions, spatial pattern selectivity, and temperature effects. These characteristics are dimensions in which the taste of sucrose is different from the tastes of natural sweeteners. Whether or not a characteristic is more sugar-like is determined by expert sensory panel assessments of sugar and compositions comprising at least one natural sweetener. Suitable procedures for determining whether a composition has a more sugar-like taste are well known in the art.

The synergy levels quoted above are the increased sweetening power per unit weight obtained for the composition as a percentage of the expected degree of sweetening power (i.e. the sum of the sweetening power theoretically provided by each of the sweeteners). An alternative and more useful measure of synergy is the percentage saving, that is to say the difference between the amount actually needed to obtain a certain degree of sweetness and the theoretical amount needed expressed as a percentage of the theoretical amount needed.

Synergy was measured by determining the concentration of each sweetener or sweetener combination having the same degree of sweetness as sucrose at a given concentration i.e. the equisweet point.

In a particular embodiment, a panel of assessors is used to measure the reduction of sweetness linger. Briefly described, a panel of assessors (generally 8 to 12 individuals) is trained to evaluate sweetness perception and measure sweetness at several time points from when the sample is initially taken into the mouth until 3 minutes after it has been expectorated. Using statistical analysis, the results are compared between samples containing additives and samples that do not contain additives. A decrease in score for a time point measured after the sample has cleared the mouth indicates there has been a reduction in sweetness perception.

The panel of assessors may be trained using procedures well known to those of ordinary skill in the art. In a particular embodiment, the panel of assessors may be trained using the Spectrum™ Descriptive Analysis Method (Meilgaard et al, Sensory Evaluation Techniques, 3rd edition, Chapter 11). Desirably, the focus of training should be the recognition of and the measure of the basic tastes; specifically, sweet. In order to ensure accuracy and reproducibility of results, each assessor should repeat the measure of the reduction of sweetness linger about three to about five times per sample, taking at least a five minute break between each repetition and/or sample and rinsing well with water to clear the mouth.

Generally, the method of measuring sweetness comprises taking a 10 mL sample into the mouth, holding the sample in the mouth for 5 seconds and gently swirling the sample in the mouth, rating the sweetness intensity perceived at 5 seconds, expectorating the sample (without swallowing following expectorating the sample), rinsing with one mouthful of water (e.g., vigorously moving water in mouth as if with mouth wash) and expectorating the rinse water, rating the sweetness intensity perceived immediately upon expectorating the rinse water, waiting 45 seconds and, while wasting those 45 seconds, identifying the time of maximum perceived sweetness intensity and rating the sweetness intensity at that time (moving the mouth normally and swallowing as needed), rating the sweetness intensity after another 10 seconds, rating the sweetness intensity after another 60 seconds (cumulative 120 seconds after rinse), and rating the sweetness intensity after still another 60 seconds (cumulative 180 seconds after rinse). Between samples take a 5 minute break, rinsing well with water to clear the mouth.

According to the method mentioned above, concentrates of apple and Luo Han Guo sweetness were measured individually and together. And increased sweetening power was determined by combination of concentrates of apple and Luo Han Guo. And “sugar-like taste” is achieved with natural sweetening composition comprising concentrates of apple and Luo Han Guo. Using less amount of sweetener is very cost-effective and production process is simple.

In this present invention, the natural sweetening composition further comprising inuline, erythritol, coconut sugar, lactose, locust bean gum; rebaudioside A, rebaudioside B, rebaudioside C, rebaudioside D, rebaudioside E, rebaudioside F, dulcoside A, dulcoside B, rubusoside, isomogroside V, 11-oxomogroside, steviol glycosides, stevia, stevioside, mogroside IV, mogroside V, mogroside VI, siamenoside, monatin and its salts (monatin SS, RR, RS, SR), curculin, glycyrrhizin, glycyrrhizic acid and its salts, thaumatin, monellin, mabinlin, brazzein, hernandulein, phyllodulcin, glycyphyllin, phloridzim, trilobatin, baiyunoside, osladin, polypodoside A, pterocaryoside A, pterocaryoside B, mukurozioside, phlomisoside I, periandrin I, abrusoside A, cyclocarioside I; a sweetener which is extracted from the group comprising Stevia rebaudiana, Glycyrrhiza glabra, Siraitia grosvenorii; sucrose, liquid sucrose, glucose, liquid glucose, fructose, liquid fructose, dextrose, galactose, lactulose, lactose, cellobiose, kojibiose, nigerose, isomaltose, -beta.,.beta.-trehalose, .alpha.,.beta.-trehalose, tagatose, sophorose, laminaribiose, gentiobiose, turanose, maltose, maltulose, palatinose, gentiobiulose, mannobiose, melibiose, melibiulose, rhamnose, ribose, rutinose, rutinulose, trehalose, xylobiose, xylose, corn syrups, fructo-oligosaccharides; erythritol, glycol, glycerol, threitol, arabitol, xylitol, ribitol, mannitol, sorbitol, dulcitol, iditol, isomalt, maltitol, lactitol, polyglycitol; apple skin extract (applephenon) or mixtures thereof.

In one embodiment, the natural sweetening composition comprising concentrates of apple and Luo Han Guo, inuline.

In another embodiment, the natural sweetening composition comprising concentrates of apple and Luo Han Guo, erythritol.

In another embodiment, the natural sweetening composition comprising concentrates of apple and Luo Han Guo, coconut sugar.

In another embodiment, the natural sweetening composition comprising concentrates of apple and Luo Han Guo, lactose.

In another embodiment, the natural sweetening composition comprising concentrates of apple and Luo Han Guo, locust bean gum.

In one embodiment, the natural sweetening composition comprising concentrates of apple and Luo Han Guo, inuline, erythritol.

In one embodiment, the natural sweetening composition comprising concentrates of apple and Luo Han Guo, inuline, erythritol, coconut sugar.

In one embodiment, the natural sweetening composition comprising concentrates of apple and Luo Han Guo, inuline, erythritol, locust bean gum.

In one embodiment, the natural sweetening composition comprising concentrates of apple and Luo Han Guo, inuline, erythritol, coconut sugar, lactose.

In one embodiment, the natural sweetening composition comprising concentrates of apple and Luo Han Guo, inuline, erythritol, coconut sugar, lactose, locust bean gum.

Use of the natural sweetening composition comprising concentrates of apple and Luo Han Guo in beverage, food, pharmaceutical, oral, dietetic, veterinary or tobacco products

In this present invention, said products are solid, liquid or semisolid.

Use of the natural sweetening composition, wherein;
said beverages are selected from the group comprising colas, ginger ales, root beers, ciders, fruit-flavored soft drinks, powdered soft drinks or mixtures thereof; fruit juices originating in fruits or vegetables, fruit juices including squeezed juices or mixtures thereof, fruit juices containing fruit particles, fruit beverages, fruit juice beverages, beverages containing fruit juices, beverages with fruit flavorings, vegetable juices, juices containing vegetables, and mixed juices containing fruits and vegetables; drinks, sport drinks, energy drinks, near water or mixtures thereof; tea type or favorite type beverages such as coffee, cocoa, chocolate, black tea, green tea, oolong tea or mixtures thereof; beverages containing milk components such as milk beverages, coffee containing milk components, cafe au lait, milk tea, fruit milk beverages, drinkable yogurt, lactic acid bacteria beverages or mixtures thereof; dairy products; alcoholic beverages such as wine, beer, cider; distilled beverages such as spirit, liquor;
said food products are selected from the group comprising bakery products; desserts such as yogurt, jellies, drinkable jellies, puddings, Bavarian cream, blancmange, cakes, brownies, mousse or mixtures thereof; sweetened food products eaten at tea time or following meals; frozen foods; cold confections, types of ice cream such as ice cream, ice milk, lacto-ice or mixtures thereof; ice confections such as sherbets, dessert ices or mixtures thereof; ice cream; general confections, baked confections or steamed confections such as cakes, crackers, biscuits, buns with bean-jam filling or mixtures thereof; rice cakes and snacks; nut and peanut butter; table top products; general sugar confections such as chewing gum, hard candy, soft candy, mints, nougat candy, jelly beans or mixtures thereof; chocolates, chocolate creams; sauces including fruit flavored sauces, chocolate sauces or mixtures thereof; edible gels; cremes including butter cremes, flour pastes, whipped cream or mixtures thereof; jams including strawberry jam, marmalade or mixtures thereof; breads including sweet breads or other starch products or mixtures thereof; spice; general condiments including seasoned soy sauce used on roasted meats, roast fowl, barbecued meat or mixtures thereof, as well as tomato catsup, sauces, noodle broth or mixtures thereof; processed agricultural products, livestock products or seafood; processed meat products such as sausage or mixtures thereof; retort food products, pickles, preserves boiled in soy sauce, delicacies, side dishes; snacks such as potato chips, cookies or mixtures thereof; wafer, waffle, cornets, bars, wafer sheet; cereal products, granola; baby food;
said pharmaceutical products are selected from the group comprising drugs or quasi-drugs that are administered orally or used in the oral cavity, wherein the drug may be in solid, liquid, gel or gas form such as a pill, tablet, spray, capsule, syrup, drop, troche agent, powder or mixtures thereof; herbal products, vitamins; nutraceutical products comprising any food or part of a food that may provide medicinal or health benefits, including the prevention and treatment of disease;
said oral products are selected from the group comprising hygienic or cosmetic products; personal care products such as other oral compositions used in the oral cavity such as mouth freshening agents, gargling agents, mouth rinsing agents, toothpaste, tooth polish, dentrifices, mouth sprays, teeth-whitening agents or mixtures thereof;
said dietetic products are selected from the group comprising dietary supplement;
said veterinary products are selected from the group comprising animal feed;
said tobacco products are selected from the group comprising smoke and smokeless tobacco products such as snuff, cigarette, pipe and cigar tobacco, and all forms of tobacco such as shredded filler, leaf, stem, stalk, homogenized leaf cured, reconstituted binders and reconstituted tobacco from tobacco dust, fines or ether sources in sheet, pellet or other forms, tobacco substitutes formulated from non-tobacco materials, dip or chewing tobacco.

In result, the art of sweetener products requires a novelty to provide the advantages of being healthy and natural, not increasing the glycemic index, production simplicity, cost-efficient and sweeter taste because of the synergy between concentrates of apple and Luo Han Guo.

1. A natural sweetening composition comprising concentrates of apple and Luo Han Guo.

2. The natural sweetening composition of claim 1, further comprising inuline, erythritol, coconut sugar, lactose, locust bean gum; rebaudioside A, rebaudioside B, rebaudioside C, rebaudioside D, rebaudioside E, rebaudioside F, dulcoside A, dulcoside B, rubusoside, isomogroside V, 11-oxomogroside, steviol glycosides, stevia, stevioside, mogroside IV, mogroside V, mogroside VI, siamenoside, monatin and its salts (monatin SS, RR, RS, SR), curculin, glycyrrhizin, glycyrrhizic acid and its salts, thaumatin, monellin, mabinlin, brazzein, hernandulein, phyllodulcin, glycyphyllin, phloridzim, trilobatin, baiyunoside, osladin, polypodoside A, pterocaryoside A, pterocaryoside B, mukurozioside, phlomisoside I, periandrin I, abrusoside A, cyclocarioside I; a sweetener which is extracted from the group consisting of Stevia rebaudiana, Glycyrrhiza glabra, Siraitia grosvenorii; sucrose, liquid sucrose, glucose, liquid glucose, fructose, liquid fructose, dextrose, galactose, lactulose, lactose, cellobiose, kojibiose, nigerose, isomaltose, .beta.,.beta.-trehalose, .alpha.,.beta.-trehalose, tagatose, sophorose, laminaribiose, gentiobiose, turanose, maltose, maltulose, palatinose, gentiobiulose, mannobiose, melibiose, melibiulose, rhamnose, ribose, rutinose, rutinulose, trehalose, xylobiose, xylose, corn syrups, fructo-oligosaccharides; erythritol, glycol, glycerol, threitol, arabitol, xylitol, ribitol, mannitol, sorbitol, dulcitol, iditol, isomalt, maltitol, lactitol, polyglycitol; apple skin extract (applephenon) or mixtures thereof.

3. The natural sweetening composition of claim 2, wherein the composition comprises concentrates of apple and Luo Han Guo, and inuline.

4. The natural sweetening composition of claim 2, wherein the composition comprises concentrates of apple and Luo Han Guo, and erythritol.

5. The natural sweetening composition of claim 2, wherein the composition comprises concentrates of apple and Luo Han Guo, and coconut sugar.

6. The natural sweetening composition of claim 2, wherein the composition comprises concentrates of apple and Luo Han Guo, and lactose.

7. The natural sweetening composition of claim 2, wherein the composition comprises concentrates of apple and Luo Han Guo, and locust bean gum.

8. The natural sweetening composition of claim 2, wherein the composition comprises concentrates of apple and Luo Han Guo, inuline, and erythritol.

9. The natural sweetening composition of claim 2, wherein the composition comprises concentrates of apple and Luo Han Guo, inuline, erythritol, and coconut sugar.

10. The natural sweetening composition of claim 2, wherein the composition comprises concentrates of apple and Luo Han Guo, inuline, erythritol, and locust bean gum.

11. The natural sweetening composition of claim 2, wherein the composition comprises concentrates of apple and Luo Han Guo, inuline, erythritol, coconut sugar, and lactose.

12. The natural sweetening composition of claim 2, wherein the composition comprises concentrates of apple and Luo Han Guo, inuline, erythritol, coconut sugar, lactose, and locust bean gum.

13. A beverage, food, pharmaceutical, oral, dietetic or veterinary product comprising a natural sweetening composition comprising concentrates of apple and Luo Han Guo.

14. The beverage, food, pharmaceutical, oral, dietetic or veterinary product of claim 13, wherein said product is solid, liquid or semisolid.

15. The beverage, food, pharmaceutical, oral, dietetic or veterinary product of claim 13, wherein:
said beverage product is selected from the group consisting of colas, ginger ales, root beers, ciders, fruit-flavored soft drinks, powdered soft drinks or mixtures thereof; fruit juices originating in fruits or vegetables, fruit juices including squeezed juices or mixtures thereof, fruit juices containing fruit particles, fruit beverages, fruit juice beverages, beverages containing fruit juices, beverages with fruit flavorings, vegetable juices, juices containing vegetables, and mixed juices containing fruits and vegetables; drinks, sport drinks, energy drinks, near water or mixtures thereof; tea type or favorite type beverages such as coffee, cocoa, chocolate, black tea, green tea, oolong tea or mixtures thereof; beverages containing milk components such as milk beverages, coffee containing milk components, cafe au lait, milk tea, fruit milk beverages, drinkable yogurt, lactic acid bacteria beverages or mixtures thereof; dairy products; alcoholic beverages such as wine, beer, cider; distilled beverages such as spirit, liquor;
said food product is selected from the group consisting of bakery products; desserts such as yogurt, jellies, drinkable jellies, puddings, Bavarian cream, blancmange, cakes, brownies, mousse or mixtures thereof; sweetened food products eaten at tea time or following meals; frozen foods; cold confections, types of ice cream such as ice cream, ice milk, lacto-ice or mixtures thereof; ice confections such as sherbets, dessert ices or mixtures thereof; ice cream; general confections, baked confections or steamed confections such as cakes, crackers, biscuits, buns with bean-jam filling or mixtures thereof; rice cakes and snacks; nut and peanut butter; table top products; general sugar confections such as chewing gum, hard candy, soft candy, mints, nougat candy, jelly beans or mixtures thereof; chocolates, chocolate creams; sauces including fruit flavored sauces, chocolate sauces or mixtures thereof; edible gels; cremes including butter cremes, flour pastes, whipped cream or mixtures thereof; jams including strawberry jam, marmalade or mixtures thereof; breads including sweet breads or other starch products or mixtures thereof; spice; general condiments including seasoned soy sauce used on roasted meats, roast fowl, barbecued meat or mixtures thereof, as well as tomato catsup, sauces, noodle broth or mixtures thereof; processed agricultural products, livestock products or seafood; processed meat products such as sausage or mixtures thereof; retort food products, pickles, preserves boiled in soy sauce, delicacies, side dishes; snacks such as potato chips, cookies or mixtures thereof; wafer, waffle, cornets, bars, wafer sheet; cereal products, granola; baby food;
said pharmaceutical product is selected from the group consisting of drugs or quasi-drugs that are administered orally or used in the oral cavity, wherein the drug may be in solid, liquid, gel or gas form such as a pill, tablet, spray, capsule, syrup, drop, troche agent, powder or mixtures thereof; herbal products, vitamins; nutraceutical products comprising any food or part of a food that may provide medicinal or health benefits, including the prevention and treatment of disease;
said oral product is selected from the group consisting of hygienic or cosmetic products; personal care products such as other oral compositions used in the oral cavity such as mouth freshening agents, gargling agents, mouth rinsing agents, toothpaste, tooth polish, dentrifices, mouth sprays, teeth-whitening agents or mixtures thereof;
said dietetic product is a dietary supplement; or
said veterinary product is an animal feed.

16. A method for making a beverage, food, pharmaceutical, oral, dietetic or veterinary product, the method comprising admixing a natural sweetening composition comprising concentrates of apple and Luo Han Guo with the other components of said beverage, food, pharmaceutical, oral, dietetic or veterinary product.

17. The method of claim 16, wherein said product is solid, liquid or semisolid.

18. The method of claim 16, wherein:
said beverage product is selected from the group consisting of colas, ginger ales, root beers, ciders, fruit-flavored soft drinks, powdered soft drinks or mixtures thereof; fruit juices originating in fruits or vegetables, fruit juices including squeezed juices or mixtures thereof, fruit juices containing fruit particles, fruit beverages, fruit juice beverages, beverages containing fruit juices, beverages with fruit flavorings, vegetable juices, juices containing vegetables, and mixed juices containing fruits and vegetables; drinks, sport drinks, energy drinks, near water or mixtures thereof; tea type or favorite type beverages such as coffee, cocoa, chocolate, black tea, green tea, oolong tea or mixtures thereof; beverages containing milk components such as milk beverages, coffee containing milk components, cafe au lait, milk tea, fruit milk beverages, drinkable yogurt, lactic acid bacteria beverages or mixtures thereof; dairy products; alcoholic beverages such as wine, beer, cider; distilled beverages such as spirit, liquor;
said food product is selected from the group consisting of bakery products; desserts such as yogurt, jellies, drinkable jellies, puddings, Bavarian cream, blancmange, cakes, brownies, mousse or mixtures thereof; sweetened food products eaten at tea time or following meals; frozen foods; cold confections, types of ice cream such as ice cream, ice milk, lacto-ice or mixtures thereof; ice confections such as sherbets, dessert ices or mixtures thereof; ice cream; general confections, baked confections or steamed confections such as cakes, crackers, biscuits, buns with bean-jam filling or mixtures thereof; rice cakes and snacks; nut and peanut butter; table top products; general sugar confections such as chewing gum, hard candy, soft candy, mints, nougat candy, jelly beans or mixtures thereof; chocolates, chocolate creams; sauces including fruit flavored sauces, chocolate sauces or mixtures thereof; edible gels; cremes including butter cremes, flour pastes, whipped cream or mixtures thereof; jams including strawberry jam, marmalade or mixtures thereof; breads including sweet breads or other starch products or mixtures thereof; spice; general condiments including seasoned soy sauce used on roasted meats, roast fowl, barbecued meat or mixtures thereof, as well as tomato catsup, sauces, noodle broth or mixtures thereof; processed agricultural products, livestock products or seafood; processed meat products such as sausage or mixtures thereof; retort food products, pickles, preserves boiled in soy sauce, delicacies, side dishes; snacks such as potato chips, cookies or mixtures thereof; wafer, waffle, cornets, bars, wafer sheet; cereal products, granola; baby food;
said pharmaceutical product is selected from the group consisting of drugs or quasi-drugs that are administered orally or used in the oral cavity, wherein the drug may be in solid, liquid, gel or gas form such as a pill, tablet, spray, capsule, syrup, drop, troche agent, powder or mixtures thereof; herbal products, vitamins; nutraceutical products comprising any food or part of a food that may provide medicinal or health benefits, including the prevention and treatment of disease;
said oral product is selected from the group consisting of hygienic or cosmetic products; personal care products such as other oral compositions used in the oral cavity such as mouth freshening agents, gargling agents, mouth rinsing agents, toothpaste, tooth polish, dentrifices, mouth sprays, teeth-whitening agents or mixtures thereof;
said dietetic product is selected from the group consisting of dietary supplement; or
said veterinary product is an animal feed.
